(19) United States
(12) Patent Application Publication
(10) Pub. No.: US 2013/0051688 A1
(43) Pub. Date: Feb. 28, 2013

(54) IMAGE PROCESSING APPARATUS, NON-TRANSITORY COMPUTER READABLE MEDIUM STORING IMAGE PROCESSING PROGRAM, AND IMAGE PROCESSING METHOD

(71) Applicant: Eiichi TANAKA, Kanagawa (JP)

(72) Inventor: Eiichi TANAKA, Kanagawa (JP)

(73) Assignee: FUJI XEROX CO., LTD., TOKYO (JP)

(21) Appl. No.: 13/351,755

(22) Filed: Jan. 17, 2012

(30) Foreign Application Priority Data
Aug. 26, 2011 (JP) 2011-184591

(51) Int. Cl. G06K 9/72

(52) U.S. Cl. 382/229

(57) ABSTRACT

An image processing apparatus includes a receiving unit that receives a size of a first character sequence component, a direction from a prefix character sequence component as a character sequence component, which is prefixed before the first character sequence component, to the first character sequence component, and a distance from the prefix character sequence component to the first character sequence component, a predicting unit that predicts a second character sequence component following the first character sequence component, a detecting unit that detects the second character sequence component in the image, a correcting unit that corrects information relating to the second character sequence component detected by the detecting unit, and a control unit that controls the receiving unit to receive as a next first character sequence component the corrected second character sequence component and causes the predicting unit, the detecting unit, and the correcting unit to repeat processing.

### CROSS-REFERENCE TO RELATED APPLICATIONS

This application is based on and claims priority under 35 USC 119 from Japanese Patent Application No. 2011-184591 filed Aug. 26, 2011.

### BACKGROUND

### Technical Field

The present invention relates to an image processing apparatus, a non-transitory computer readable medium storing an image processing program, and an image processing method.

### SUMMARY

According to an aspect of the invention, there is provided an image processing apparatus including: a receiving unit that receives a size of a first character sequence component, a direction from a prefix character sequence component as a character sequence component, which is prefixed before the first character sequence component, to the first character sequence component, and a distance from the prefix character sequence component to the first character sequence component, as information relating to the first character sequence component in an image; a predicting unit that predicts a second character sequence component following the first character sequence component based on the information relating to the first character sequence component received by the receiving unit; a detecting unit that detects the second character sequence component in the image based on the second character sequence component predicted by the predicting unit; a correcting unit that corrects information relating to the second character sequence component detected by the detecting unit based on information relating to character sequence components in the past; and a control unit that controls the receiving unit to receive as a next first character sequence component the second character sequence component corrected by the correcting unit and causes the predicting unit, the detecting unit, and the correcting unit to repeat processing.

### BRIEF DESCRIPTION OF THE DRAWINGS

Exemplary embodiments of the present invention will be described in detail based on the following figures, wherein:

FIG. 1 is a conceptual module configuration diagram of a configuration example according to a first exemplary embodiment;

FIG. 2 is an explanatory diagram showing an example of a target handwritten document image;

FIG. 3 is an explanatory diagram showing an example of a result obtained by performing quasi-character analysis on a handwritten document image;

FIGS. 4A to 4C are explanatory diagrams showing an example of a character sequence to be detected and processing thereof;

FIG. 5 is an explanatory diagram showing an example of a character sequence detection result;

FIG. 6 is an explanatory diagram showing an example of information relating to a character sequence component;

FIG. 7 is an explanatory diagram showing an example of information relating to a character sequence component;

FIG. 8 is a flowchart showing a processing example according to the first exemplary embodiment;

FIG. 9 is an explanatory diagram showing an example of character sequence component predicting processing;

FIG. 10 is an explanatory diagram showing an example of character sequence component detecting processing;

FIG. 11 is an explanatory diagram showing an example of character sequence component correcting processing;

FIG. 12 is a conceptual module configuration diagram of a configuration example according to a second exemplary embodiment;

FIG. 13 is a conceptual module configuration diagram of a configuration example according to a third exemplary embodiment;

FIG. 14 is a flowchart showing a processing example according to the third exemplary embodiment;

FIG. 15 is a conceptual module configuration diagram of a configuration example according to a fourth exemplary embodiment;

FIG. 16 is a conceptual module configuration diagram of a configuration example according to a fifth exemplary embodiment;

FIG. 17 is a flowchart showing a processing example according to the fifth exemplary embodiment;

FIG. 18 is a conceptual module configuration diagram of a configuration example according to a sixth exemplary embodiment;

FIG. 19 is a flowchart showing a processing example according to the sixth exemplary embodiment;

FIG. 20 is a conceptual module configuration diagram of a configuration example according to a seventh exemplary embodiment; and

FIG. 21 is a block diagram showing a hardware configuration example of a computer which realizes exemplary embodiments.

### DETAILED DESCRIPTION

First, description will be given of an outline of exemplary embodiments which will be described later. The exemplary embodiments belong to a technique of clipping a character sequence from an image. The character sequence clipping technique means a technique according to which each character sequence is detected in a document image (a bitmap image, a vector image, a stroke image, or the like) including the character sequence.

There are two basic approaches including a top-down approach and a bottom-up approach for the character sequence clipping technique.

The top-down approach is an approach according to which a character sequence is detected by dividing a big picture region. The bottom-up approach is an approach according to which a character sequence is detected by combining local regions.

The exemplary embodiments belong to the character sequence clipping technique based on the bottom-up approach. According to the character sequence clipping apparatus based on the bottom-up approach, the local regions to be combined for detecting a character sequence are referred to as quasi-characters. For example, quasi-characters include connected component (a four-connected pixel block or an eight-connected pixel block) of a binary image or vector information. Each of the quasi-characters represents one character or a part of one character, for example, “a left-hand radical, a right-hand radical” or the like of a Chinese character. Information relating to the quasi-characters includes a position of each pixel constituting a quasi-character within an image, a position of a circumscribed rectangle of a quasi-character, a size, and the like, for example.

There are various shapes of character sequences depending on a document image, and there is a case in which many characters, each of which is constituted by multiple quasi-characters, are included.

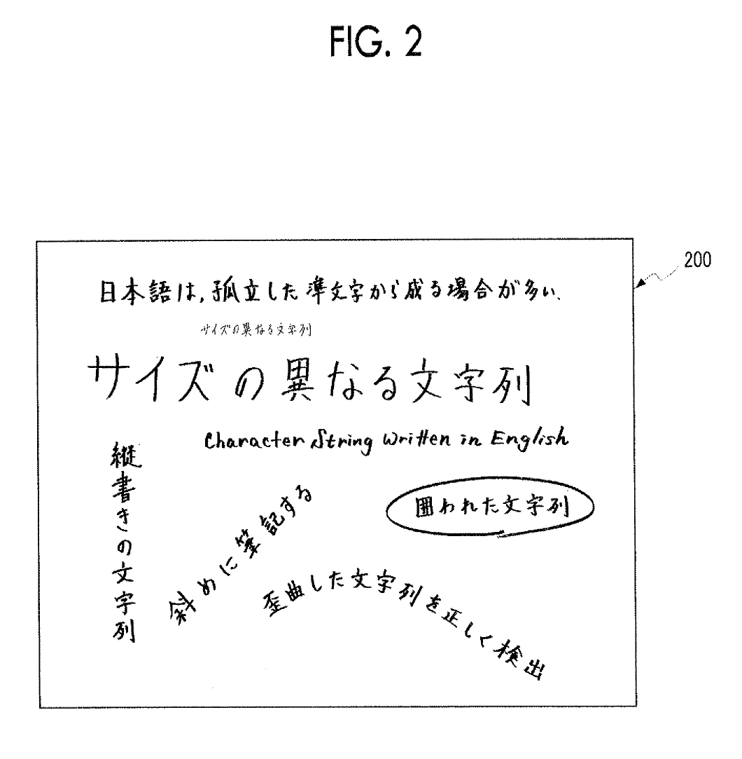

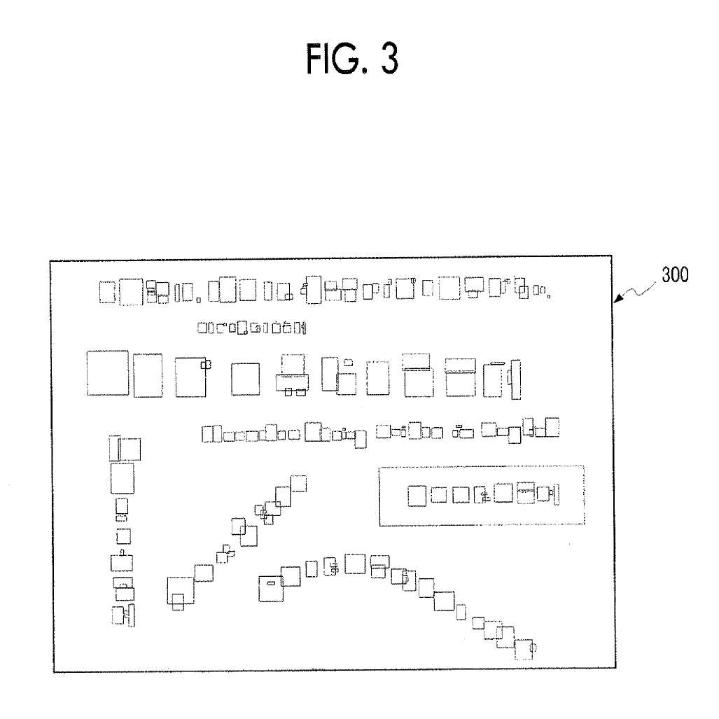

FIGS. 2 and 3 show an example in which a connected component of a binary image is included as a quasi-character. FIG. 2 shows an example of a handwritten document image 200, and a document image (connected component) 300 shown in the example of FIG. 3 is an example of a result obtained by performing quasi-character analysis on the handwritten document image 200 shown in the example of FIG. 2.

The state in which there are various shapes of character sequences means a state in which character sequences with different sizes, an oblique character sequence, or a distorted (curved) character sequence are present at the same time as shown in the example of FIG. 2.

The state in which many single characters, each of which includes multiple quasi-characters, are included means a state in which characters, each of which includes “left-hand radical and right-hand radical”, are included in Japanese. It can be understood from the examples in FIGS. 2 and 3 that orders and the like of quasi-characters are different from each other in English and in Japanese.

It is assumed that a character sequence is a group of character sequence components. In addition, it is assumed that a character sequence component includes a single quasi-character or multiple quasi-characters. According to this exemplary embodiment, the shape of a character sequence is estimated based on the character sequence components detected in the past. Then, a following character sequence component is detected based on a certain character sequence component. At this time, quasi-characters are combined based on the estimated shape of the character, and the following character sequence component is detected. The above processing is repeated until the detection of the following character sequence component is failed. The detection of the character sequence components by the repetition will be referred to as “character sequence tracking”.

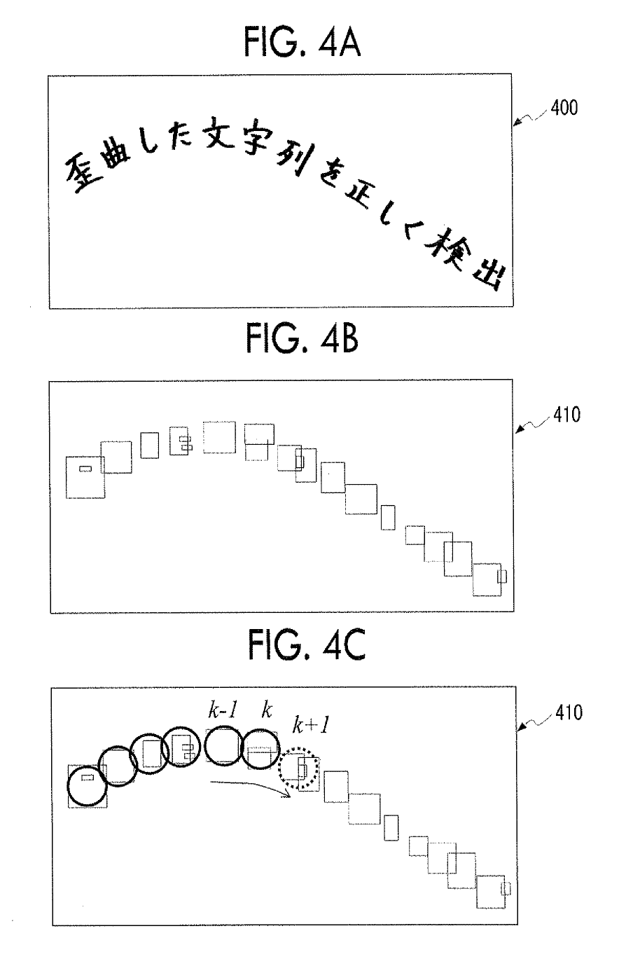

FIGS. 4A to 4C are diagrams schematically showing the character sequence tracking according to this exemplary embodiment. First, quasi-characters are detected in a document image 400 as shown in FIG. 4A. A document image (connected component) 410 shown in the example of FIG. 4B is obtained as the detection result. In the examples of FIGS. 4A to 4C, the quasi-characters are shown by rectangles. In addition, the character sequence components are shown by circles.

Hereinafter, specific description will be given of the character sequence tracking.

It is assumed that the character sequence components up to the k-th character sequence component have been detected until now in certain character sequence tracking. Next, it is desired to detect the following k+1-th character sequence. Therefore, a region in which the following character sequence component should be present is estimated. To do so, the shape of the character sequence to be detected may be estimated based on the character sequence components observed in the past. This estimation is realized by regression analysis. In addition, successive computation may also be used in view of the processing speed and the memory as indicated in “Text Line Extraction in Handwritten Document with Kalman Filter Applied on Low Resolution Image,” (Aurelie Lemaitre, Jean Camillerapp, Proceedings of the Second International Conference on Document Image Analysis for Libraries (DIAL'06), 2006.).

It is possible to predict the region in which the k+1-th character sequence component should be present from the estimated shape of the character sequence. In the example of FIG. 4C, the predicted k+1-th character sequence component is shown by a circle depicted by a broken line. The quasi-characters are detected based on the predicted character sequence component. At this time, when there are multiple quasi-characters in the predicted region of the character sequence component, the multiple quasi-characters are combined.

If the following character sequence component is not detected, the character sequence tracking is terminated.

By performing the detection after the estimation as described above, information to be referred to for the detection (that is, the size and the direction of the character sequence) is obtained for each character sequence. That is, the problem of the variety in the shapes of the character sequences is addressed. In addition, it is possible to extract even a single character including multiple quasi-characters as a character sequence component by combining the multiple quasi-characters within the predicted region of the character sequence component.

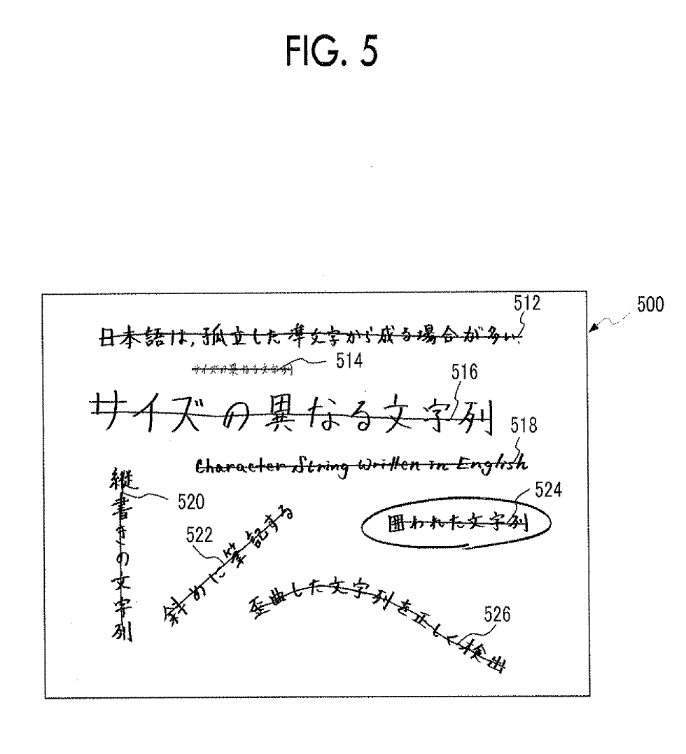

FIG. 5 is an explanatory diagram showing an example of a character sequence detection result according to this exemplary embodiment.

For example, eight character sequences can be extracted from a document image 500, and character sequence centerlines 512, 514, 516, 518, 520, 522, 524, and 526 are shown. That is, a character sequence is detected in a document image 500 including various shapes of character sequences and including many single characters, each of which is constituted by multiple quasi-characters. In addition, it is not necessary to distinguish noise from characters for the quasi-characters in the document image 500 including figures and noise which are not characters.

### <Concerning Quasi-Characters and Character Sequence Components>

According to this exemplary embodiment, a character sequence is detected as a group of character sequence components.

As described above, a character sequence component includes a single quasi-character or multiple quasi-characters.

The quasi-character in this exemplary embodiment is one of (A) a connected component of a binary image, (B) stroke data of a stroke image, and (C) vector data of a vector image.

The character sequence component according to this exemplary embodiment includes at least the following information in order to estimate the shape of the character sequence: (I) t: sizes of character sequence components, (II) θ: directions of character sequence components, and (III) p: intervals between character sequence components.

Here, θ represents a direction from a character sequence component (k−1) to a character sequence component (k) when a target character sequence component is assumed to be a k-th detected character sequence component (described as a character sequence component (k)) and a character sequence component detected immediately before the k-th character sequence is assumed to be a k−1-th detected character sequence component (described as a character sequence component (k−1)).

p (intervals between character sequence components) represents a distance between the character sequence component (k−1) and the character sequence component (k).

In addition, the character sequence component may include information not about quasi-characters but about positions. In such a case, only quasi-characters within a range designated by the positions and the sizes of the character sequence components may be detected from among the quasi-characters held in advance to obtain a character sequence. In relation to θ as the direction, the differential value thereof may also be included. It is possible to detect a distorted character sequence by considering the differential value of the direction.

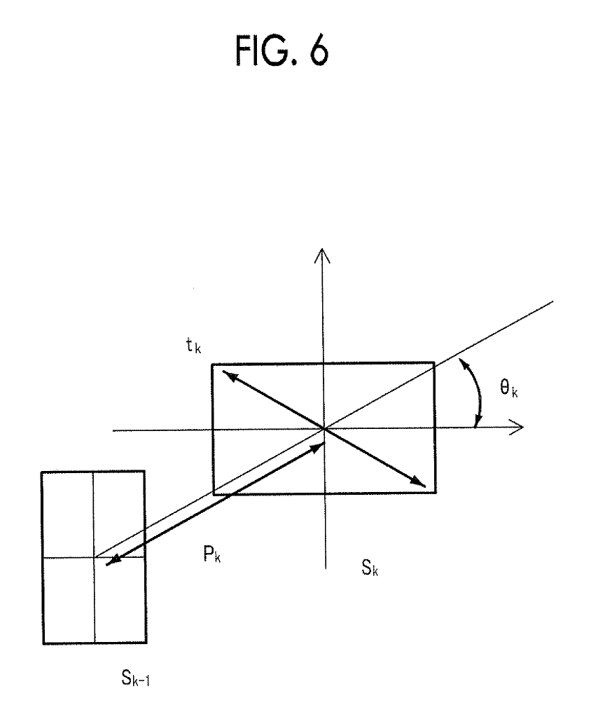

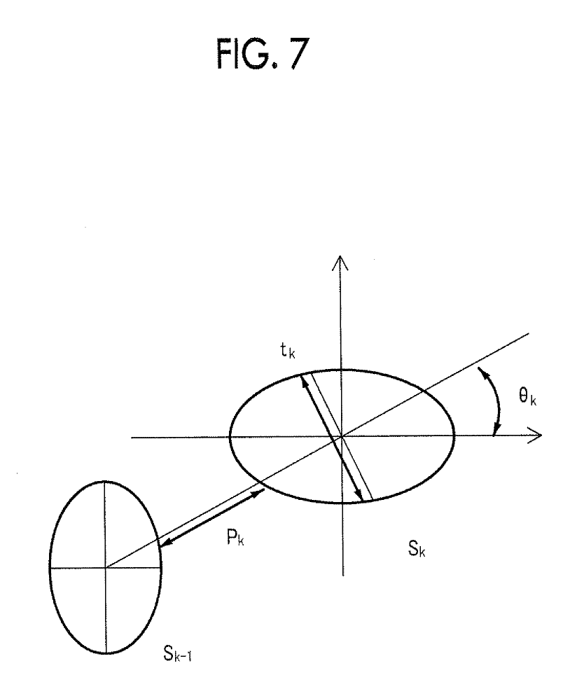

FIGS. 6 and 7 show specific examples. The regions surrounded by broke lines represent the prediction of the following character sequence components.

First, description will be given of the example shown in FIG. 6. In the example of FIG. 6, the character sequence components are shown by rectangles. For example, such rectangles are circumscribed rectangles surrounding character sequence components. In addition, t, θ, and p are given as follows.

(I) t: a length of a diagonal line (tₖ) of a rectangle (Sₖ) as a target character sequence component,

(II) θ: an inclination (θₖ) of a line connecting a center coordinate of the rectangle (Sₖ) as the target character sequence component and a center coordinate of a rectangle (Sₖ₋₁) as a prefix character sequence component, and

(III) p: a distance (pₕ) between the center coordinate of the rectangle (Sₖ) as the target character sequence component and the center coordinate of the rectangle (Sₖ₋₁) as the prefix character sequence component.

Otherwise, t may represent a vertical length, a horizontal length, an area of the rectangle, θ may represent an inclination between right upper ends of rectangles, p may represent a length obtained by subtracting a part overlapping both rectangles from the distance between center coordinates.

In addition, description will be given of the example shown in FIG. 7. In the example of FIG. 7, the character sequence components are shown by ellipses. For example, the ellipses are minimum ellipses surrounding the character sequence components. In addition, t, θ, p are given as follows.

(I) t: a length (tk) of a straight line overlapping the ellipses, where the straight line passes through the center of the ellipse (Sₖ) as a target character sequence component and the inclination is expressed as θₖ+π/2,

(II) θ: an inclination (θₖ) of a line connecting a center coordinate of the ellipse (Sₖ) as the target character sequence component and a center coordinate of the ellipse (Sₖ₋₁) as a prefix character sequence component, and

(III) p: a length (pₖ) obtained by subtracting a part overlapping both ellipses from the distance between the center coordinate of the ellipse (Sₖ) as the target character sequence component and the center coordinate of the ellipse (Sₖ₋₁) as the prefix character sequence component.

Otherwise, t may represent a longer diameter, a shorter diameter, a longer diameter×a shorter diameter, an area, or the like, θ may represent an inclination between upper right ends of the ellipses, and p may represent a distance between center coordinates.

Herein after, various exemplary embodiments for realizing the present invention will be described with reference to the drawings.

### First Exemplary Embodiment

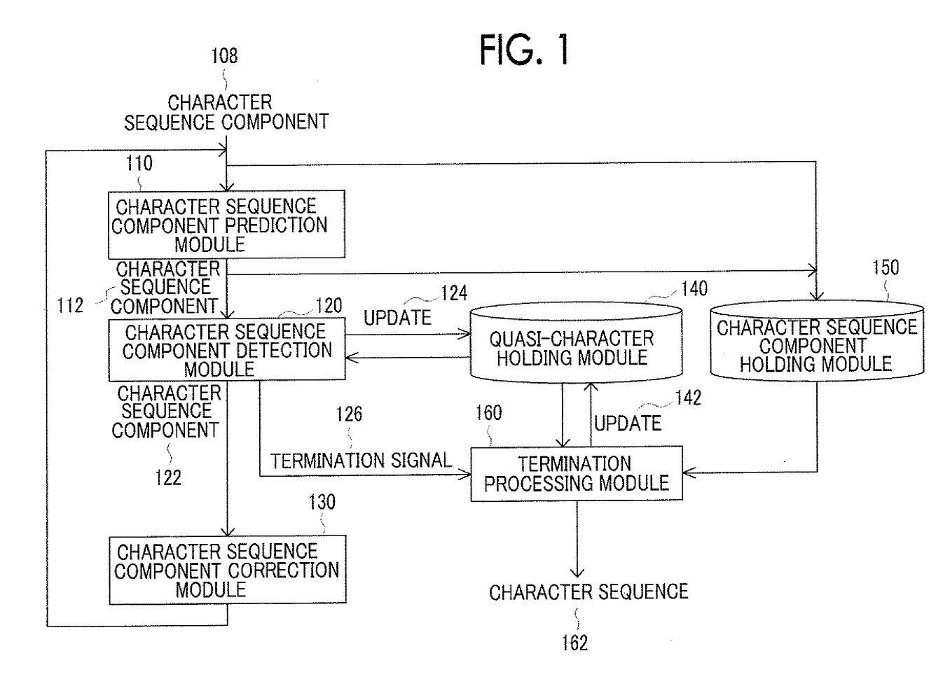

FIG. 1 is a conceptual module configuration diagram of a configuration example according to a first exemplary embodiment.

In addition, a module represents a component such as software (a computer program), or hardware which can be logically separated in general. Therefore, the modules in the exemplary embodiments are not limited to modules in a computer program but also represent modules in a hardware configuration. For this reason, the exemplary embodiments includes the description of a computer program (a program causing a computer to execute each procedure, a program causing a computer to function as each unit, a program causing a computer to realize each function), a system, and a method which are made to function as such modules. Although “store”, “made to store”, and other equivalent expressions are used for convenience of description, such expressions mean that a computer program makes a storage device store something or that a computer program controls a storage device to store something, when the exemplary embodiment is related to a computer program. Although a module may have a one-to-one correspondence relationship for implementations, one module may be configured by one program, multiple modules may be configured by one program, or one module may be configured by multiple programs in the opposite manner. In addition, multiple modules may be executed by one computer, or one module may be executed by multiple computers in a distributed or parallel environment. In addition, one module may include another module. Hereinafter, an expression “connection” is used for a case of logical connection (exchanging of data, instructions, reference relationships between data, and the like) as well as physical connection. An expression “predetermined” means that determination is made before target processing and is used such that the expression includes the meaning that the determination is made in accordance with a condition and a state at that time or in accordance with a condition and a state until then even after the start of the processing of the exemplary embodiment as long as the determination is made before the target processing, as well as the meaning that the determination is made before the processing of the exemplary embodiment.

In addition, a system or an apparatus includes the case in which a system or an apparatus is implemented by one computer, hardware, an apparatus, or the like as well as a configuration in which multiple computers, hardware, apparatuses, and the like are connected via a communication unit such as a network (including communication connection of one-to-one correspondence relationship). The expressions “apparatus” and “system” are used as terms with the same meaning. It is a matter of course that the “system” excludes what are merely societal “mechanisms” (“social systems”), which is an artificial rule.

The target information is read from a storage device for every processing by each module or for every processing when multiple kinds of processing are performed in a module, and a processing result is written in the storage device after the reading processing. Accordingly, description relating to reading from the storage device before the processing and the writing in the storage device after the processing may be omitted in some cases. In addition, the storage device here may include a hard disk, a RAM (Random Access Memory), an external storage medium, storage apparatus via a communication line, a register in a CPU (Central Processing Unit), and the like.

The image processing apparatus according to the first exemplary embodiment extracts a character sequence from a document image, and includes a character sequence component prediction module 110, a character sequence component detection module 120, a character sequence component correction module 130, a quasi-character holding module 140, a character sequence component holding module 150, and a termination processing module 160 as shown in the example of FIG. 1.

In the character sequence tracking, processing of firstly receiving a start character sequence component and detecting a character sequence with reference to a set of quasi-characters is repeatedly performed.

The character sequence component prediction module 110 is connected to the character sequence component detection module 120, the character sequence component correction module 130, and the character sequence component holding module 150. The character sequence component prediction module 110 receives a size of a first character sequence component, a direction from a prefix character sequence component before the first character sequence component to the first character sequence component, and a distance between the prefix character sequence component and the first character sequence component, as information relating to the first character sequence component within an image. In addition, the character sequence component prediction module 110 receives aforementioned t, θ, and p for the character sequence component 108. Furthermore, the character sequence component prediction module 110 may receive a differential value of the direction from the prefix character sequence component to the first character sequence component.

Then, the character sequence component prediction module 110 predicts a second character sequence component following the first character sequence component based on the received information relating to the first character sequence component. That is, the following character sequence component 112 is predicted from the character sequence component (the character sequence component 108, the character sequence component corrected by the character sequence component correction module 130, or the character sequence component held by the character sequence component holding module 150) obtained in the past. The following character sequence component 112 means the next component in an order of detecting character sequence components, and means a character sequence component to be extracted after the last character sequence component extracted in the past (the character sequence component passed by the character sequence component correction module 130). It is matter of course that the following character sequence component 112 is adjacent to the extracted last character sequence component. In the case of receiving the differential value, the second character sequence component is predicted by adding the differential value to the information relating to the first character sequence component.

The character sequence component detection module 120 is connected to the character sequence component prediction module 110, the character sequence component correction module 130, the quasi-character holding module 140, and the termination processing module 160. The character sequence component detection module 120 detects the second character sequence component in the image based on the second character sequence component predicted by the character sequence component prediction module 110. Specifically, the character sequence component detection module 120 detects quasi-characters included in the predicted character sequence component region from the quasi-character holding module 140, combines the quasi-characters, and regards the combined quasi-characters as the following character sequence component 122. Since it is matter of course that some quasi-characters are partially included in the predicted character sequence component region, there is a case in which the sizes and the like of the predicted character sequence component and of the detected character sequence component are different from each other.

The character sequence component correction module 130 is connected to the character sequence component prediction module 110, the character sequence component detection module 120, and the character sequence component holding module 150. The character sequence component correction module 130 corrects the information relating to the second character sequence component, which has been detected by the character sequence component detection module 120, based on the information relating to the character sequence components in the past. Then, the character sequence component correction module 130 passes the corrected information relating to the second character sequence component to the character sequence component prediction module 110 and cause the character sequence component holding module 150 to hold the corrected information. In this processing, the shape of the character sequence to be detected is estimated with reference to the character sequence components detected in the past.

Then, the image processing apparatus controls the character sequence component prediction module 110 to receive the second character sequence component, which has been corrected by the character sequence component correction module 130, as the next first character sequence component and causes the character sequence component prediction module 110, the character sequence component detection module 120, and the character sequence component correction module 130 to repeat the processing.

The quasi-character holding module 140 is connected to the character sequence component detection module 120 and the termination processing module 160. The quasi-character holding module 140 holds the information relating to the quasi-characters within the target image. The information is accessed by the character sequence component detection module 120 and the termination processing module 160, subjected to the update 124 by the character sequence component detection module 120, and subjected to the update 142 by the termination processing module 160.

The character sequence component holding module 150 is connected to the character sequence component prediction module 110, the character sequence component correction module 130, and the termination processing module 160. The character sequence component holding module 150 holds information relating to the character sequence component, which has been corrected by the character sequence component correction module 130.

When the second character sequence component cannot be detected (when the quasi-characters are not detected in the predicted character sequence component region, for example) the character sequence component detection module 120, or when a difference between the information relating to the detected second character sequence component and the information relating to the second character sequence component, which has been predicted by the character sequence component prediction module 110, is greater or not less than a predetermined value, a termination signal 126 is output to the termination processing module 160.

The termination processing module 160 is connected to the character sequence component detection module 120, the quasi-character holding module 140, and the character sequence component holding module 150. When the termination signal 126 is received, the termination processing module 160 combines the character sequence components obtained in the past, which are held in the character sequence component holding module 150, and output the character sequence components as a character sequence 162. The combining of character sequence components here means obtaining a character sequence by coupling character sequences, and a configuration is applicable in which an identifier for identifying each character sequence at least in an image (a character sequence identifier) is given and the character sequence identifier is given to the character sequence component included in the character sequence, for example. Alternatively, another configuration is also applicable in which information relating to the character sequence is generated from the information relating to the character sequence component included in the character sequence. Examples of the information relating to the character sequence includes a start point, a termination point, a position of a center line (which may be expressed by a function, if possible, or may be an x coordinate, a y coordinate, or the like of each pixel of the center line), a thickness (a thickness at each position on the center line when the thickness is not uniform), and the like of the character sequence.

In addition, information indicating that the detection has already been completed is added to the quasi-characters within the quasi-character holding module 140 in the repeating processing, in order to prevent the situation that the processing is not completed due to the overlapping detection of the same quasi-character (the update 142 processing of the quasi-characters). When another character sequence is subsequently detected, the information indicating that the detection has already been completed is initialized by the termination processing module 160.

The outputs of the character sequence may include not only causing a storage medium such as a memory card to store the information relating to the character sequence and passing the information to another information processing apparatus (a character recognition apparatus or the like, for example) but also extracting only the character sequence from the image to display the character sequence on a display apparatus such as a display, transmitting the image by an image transmission apparatus such as a facsimile, and writing the image in an image storage apparatus such as image database.

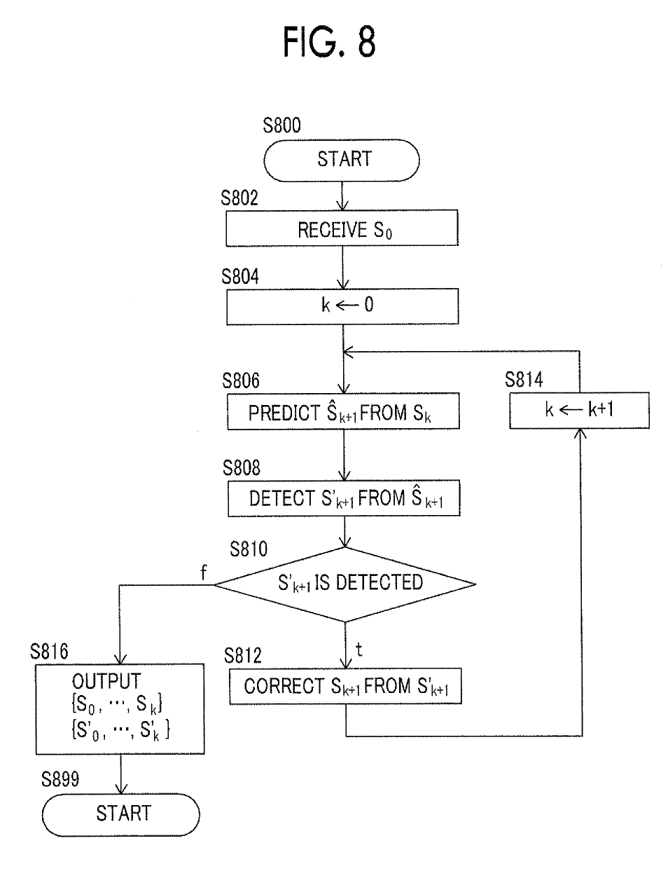

FIG. 8 is a flowchart showing a processing example according to a first exemplary embodiment.

In Step S802, the character sequence component prediction module 110 receives s₀.

In Step S804, the character sequence component prediction module 110 substitutes 0 into a variable k.

In Step S806, the character sequence component prediction module 110 predicts from sₖ Equation 1.

ŝₖ₊₁ (1)

In Step S808, the character sequence component detection module 120 detects s′ₖ₊₁ in the image from Equation 1.

ŝₖ₊₁ (1)

In Step S810, the character sequence component detection module 120 determines whether or not s′ₖ₊₁ has been detected, and the processing proceeds to Step S812 when s′ₖ₊₁ has been detected, or otherwise the processing proceeds to Step S816.

In Step S812, the character sequence component correction module 130 corrects sₖ₊₁ based on s′ₖ₊₁.

In Step S814, the character sequence component correction module 130 substitutes a variable k+1 into the variable k. That is, the character sequence component correction module 130 increments the variable k. In Step S816, the termination processing module 160 outputs {s₀, . . . , sₖ)} {s′₀, . . . , s′ₖ}.

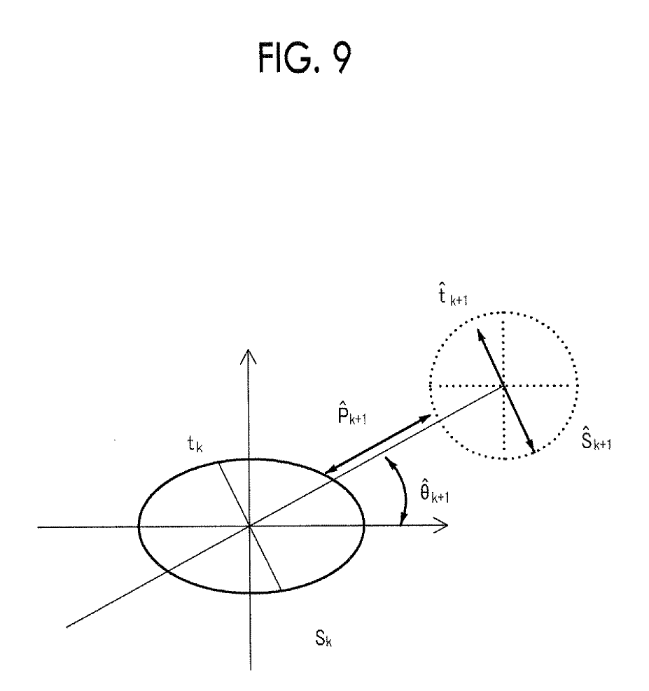

FIGS. 9 to 11 are diagrams schematically illustrating operations according to the first exemplary embodiment.

FIG. 9 is an explanatory diagram showing an example of character sequence component prediction processing.

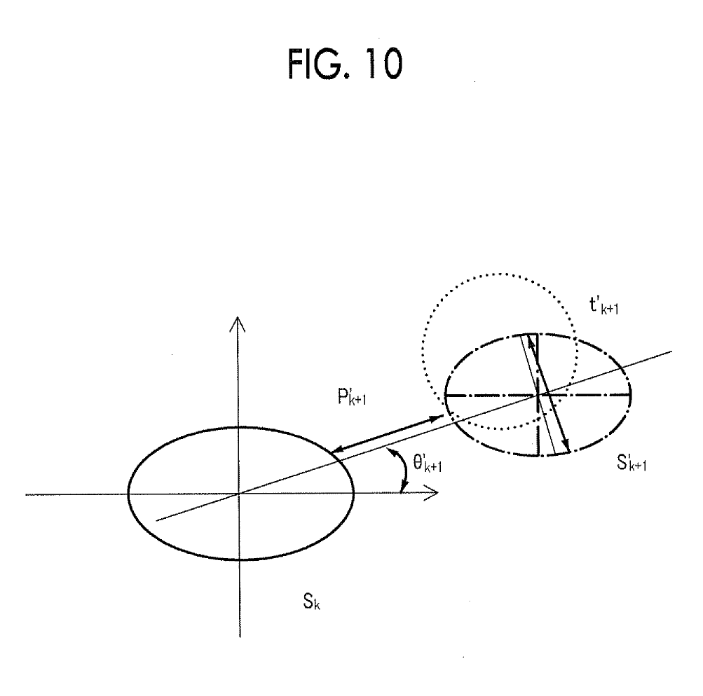

FIG. 10 is an explanatory diagram showing an example of character sequence component detection processing.

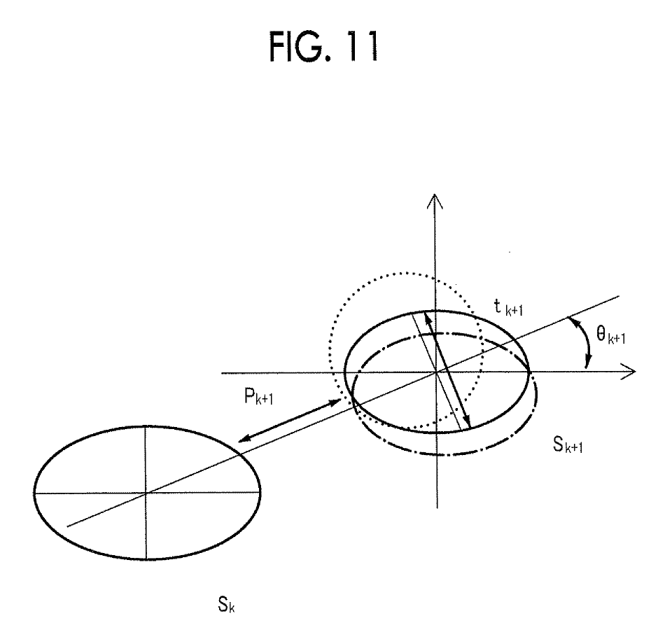

FIG. 11 is an explanatory diagram showing an example of character sequence component correction processing.

In FIGS. 9 to 11, Sₖ represents a last obtained character sequence component. In addition, Equation 1 represents a predicted character sequence component.

ŝₖ₊₁ (1)

Moreover, s′ₖ₊₁ represents a detected character sequence component.

Furthermore, sₖ₊₁ represents a character sequence component obtained by estimating a character sequence based on the character sequence component obtained in the past and correcting s′ₖ₊₁ based on the estimation.

Although the description using the examples in FIGS. 9 to 11 is for the example of FIG. 7 in which the character sequence components are shown by ellipses, the same is true for the case of FIG. 6 in which the character sequence components are shown by rectangles.

The character sequence component prediction module 110 outputs based on sₖ obtained in the past Equation 1.

ŝₖ₊₁ (1)

In addition, the character sequence component prediction module 110 obtains a region shown by Equation 1.

ŝₖ₊₁ (1)

The state will be shown in the example of FIG. 9.

First, Equations 3, 4, and 5.

\hat{t}ₗ₊₁ (3)

\hat{θ}ₖ₊₁ (4)

\hat{p}ₖ₊₁ (5)

as the information included in Equation 1.

ŝₖ₊₁ (1)

are obtained. The information may be the information itself held by sₖ (that is, tₖ, θₖ, and pₖ are substituted into Equations 3, 4, and 5). If at least one of t, θ, and p includes information including a differential value (a difference between adjacent character sequence components), the differential value may be added to tₖ, θₖ, and pₖ.

Next, the position of Equation 1 is obtained based on the position of sₖ and the information held in Equation 1.

ŝₖ₊₁ (1)

The character sequence component detection module 120 outputs s′ₖ₊₁ based on Equation 1.

ŝₖ₊₁ (1)

The state will be shown in the example of FIG. 10.

First, the quasi-characters included in the region expressed by Equation 1:

ŝₖ₊₁ (1)

are detected from the quasi-character holding module 140. At this time, the number of quasi-characters may be multiple. Then, t′ₖ₊₁, θ′ₖ₊₁, and p′ₖ₊₁ as the information held by s′ₖ₊₁ are obtained. These t′ₖ₊₁, θ′ₖ₊₁, and p′ₖ₊₁ are calculated based on the character sequence component obtained by combining the quasi-characters and sₖ. Specifically, the size (t) of the region at which actually detected quasi-characters are positioned, the angle (θ) between the center coordinate of the region and the center coordinate of sₖ, and the length (p) obtained by subtracting a part overlapping both ellipses from the distance between the center coordinate of the region and the center coordinate of sₖ are calculated.

The character sequence component correction module 130 outputs sₖ₊₁ based on s′ₖ₊₁ and the character sequence components obtained in the past. The state will be shown in the example of FIG. 11. Since s′ₖ₊₁ is an actually measured value, s′ₖ₊₁ includes noise. The influence of the noise is corrected by referring to the character sequence components obtained in the past.

In the character sequence tracking, the above processing is repeatedly performed. When a character sequence component is not detected by the character sequence component detection module 120 shown in the example of FIG. 10, the processing is completed. The state that “a character sequence component is not detected” means the state in which there is no quasi-character in the predicted character sequence component region. In addition, when a value of difference between the information relating to s′ₖ and the information relating to Equation 2:

ŝₖ (2)

is greater or not less than a predetermined value while quasi-characters are present in the region indicated by the predicted character sequence component, the processing is completed. At this time, the dispersion of the character sequence components detected in the past may be referred to as the predetermined value.

Alternatively, a configuration is also applicable in which the processing is completed when the number of times a character sequence component is not detected by the character sequence component detection module 120 or the value of difference is greater or not less than the predetermined value is greater or not less than a predetermined number of times. Estimation of character sequence component by sequential computation

An example will be shown in which the estimation of the size and the shape of the character sequence by the character sequence component prediction module 110, the character sequence component detection module 120, and the character sequence component correction module 130 according to the first exemplary embodiment shown in the example of FIG. 1 is performed by sequential computation.

The estimation of the size and the shape of the character sequence is realized by performing regression computation with the use of all character sequence components obtained in the past. However, it is possible to enhance the memory capacity and the calculation speed if implementation is made by the following sequential computation.

In the following sequential computation, dispersion information P corresponding to a value x to be estimated (namely, one of t, θ, and p) is sequentially held and updated. This corresponds to a narrowly defined Kalman filter (Greg Welch, Gary BishopAurelie, “An introduction to the Kalman Filter,” 2006). In addition, Q and R are dispersion information of an error relating to the value x to be estimated, which are predetermined values.

The following calculation is respectively performed.

First, the following calculation (Equations 6 and 7) is performed by the character sequence component prediction module 110.

\hat{x}ₖ₊₁=Axₖ (6)

\hat{P}ₖ₊₁=APₖA^{T}+Q (7)

In addition, the following calculation (Equations 8, 9, and 10) is performed by the character sequence component correction module 130.

xₖ₊₁=\hat{x}ₖ₊₁+Kₖ₊₁(x_{K+1}⁰−\hat{x}ₖ₊₁) (8)

Pₖ₊₁=(I−Kₖ₊₁)\hat{P}ₖ₊₁ (9)

Kₖ₊₁=\hat{P}ₖ₊₁(\hat{P}ₖ₊₁+R)⁻¹ (10)

In addition, when the value x to be estimated holds information regarding the differential value, x and P are represented by a two-dimensional matrix, and A is given as the following Equation 11.

$$A = ( \begin{matrix}1 & 1 \\ 0 & 1\end{matrix} ) \qquad ( 11 )$$

When the value x to be estimated does not hold the information regarding the differential value, x and P are scalar, and A is given as the following Equation 12.

A=1 (12)

### Second Exemplary Embodiment

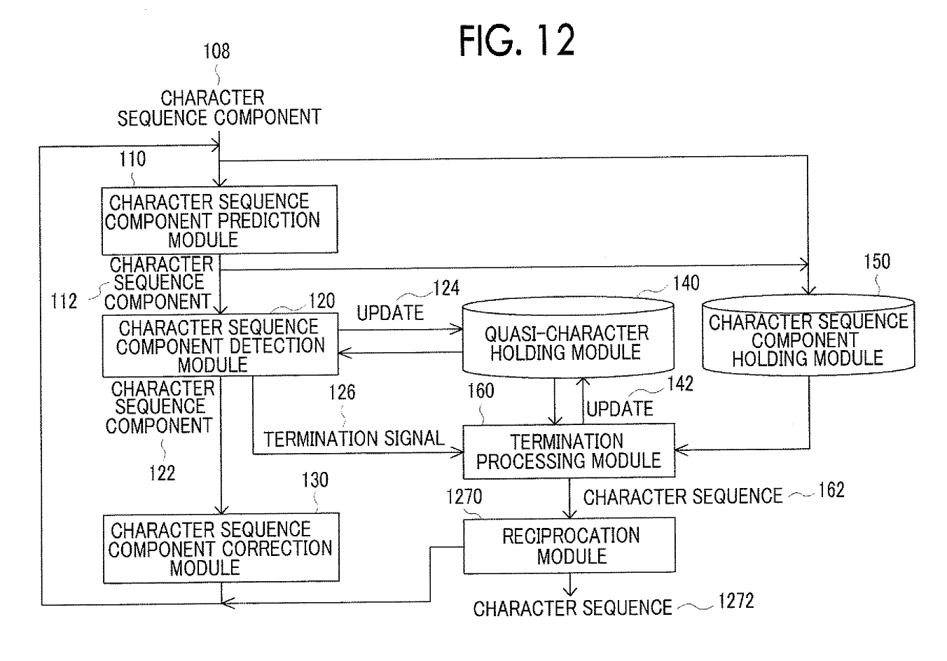

FIG. 12 is a conceptual module configuration diagram of a configuration example according to a second exemplary embodiment.

According to the second exemplary embodiment, a start character sequence component is obtained by reciprocating the character sequence tracking processing, and the character sequence component prediction module 110, the character sequence component detection module 120, the character sequence component correction module 130, the quasi-character holding module 140, the character sequence component holding module 150, the termination processing module 160, and a reciprocation module 1270 are provided as shown in the example of FIG. 12. Here, the same reference numerals are added to the similar components to those in the first exemplary embodiment, and the description thereof will not be repeated (the same is true in the following description).

For the purpose of character sequence tracking, it is desired that a first character sequence component in a character sequence is positioned at an end of the character sequence. According to the second exemplary embodiment, the character sequence component at an end of the character sequence is detected by the reciprocation processing. That is, according to the outline of the processing in the second exemplary embodiment, the character sequence tracking is performed in the opposite direction when a termination condition is satisfied in the first exemplary embodiment, and a point at which the termination condition is satisfied again is regarded as the end. In addition, the reciprocation processing may be repeated multiple times.

The character sequence component prediction module 110 is connected to the character sequence component detection module 120, the character sequence component correction module 130, the character sequence component holding module 150, and the reciprocation module 1270.

The termination processing module 160 is connected to the character sequence component detection module 120, the quasi-character holding module 140, the character sequence component holding module 150, and the reciprocation module 1270.

The reciprocation module 1270 is connected to the character sequence component prediction module 110 and the termination processing module 160. When the termination processing module 160 determines that the character sequence tracking processing for one character sequence has been completed (when the termination processing module 160 outputs a character sequence 162 to the reciprocation module 1270), the reciprocation module 1270 regards the last character sequence component detected in the character sequence tracking processing (the character sequence component at the last point) as a first character sequence component. Then, the reciprocation module 1270 inverts the direction of the character sequence tracking. That is, the reciprocation module 1270 passes the first character sequence component to the character sequence component prediction module 110 and changes the direction of the character sequence component predicted by the character sequence component prediction module 110 into a direction opposite to the direction of the character sequence tracking until then, in order to perform the character sequence tracking processing again in the opposite direction. Then, the processing by the character sequence component prediction module 110, the character sequence component detection module 120, and the character sequence component correction module 130 are repeated in the same manner as in the first exemplary embodiment. When the termination processing module 160 determines again that the character sequence tracking processing has been completed up to the end of the character sequence, the character sequence 1272 is output. Such reciprocation processing may be repeated multiple times. The reciprocation processing may be repeated a predetermined number of times or may be completed when the end detected last time is at the same position (or when an interval between the end detected last time and the end detected this time is not more than or less than a predetermined distance). Then, the character sequence 162 received at last is output as the character sequence 1272.

### Third Exemplary Embodiment

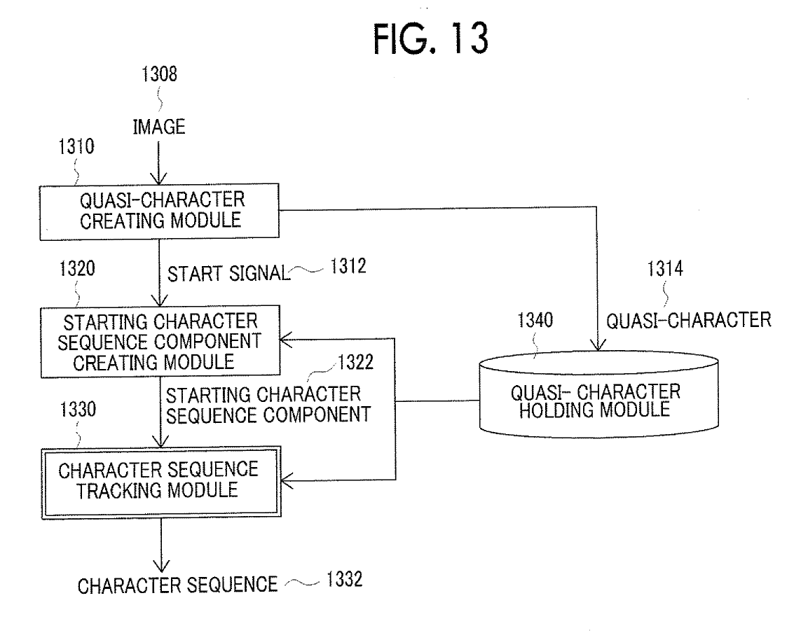

FIG. 13 is a conceptual module configuration diagram of a configuration example according to a third exemplary embodiment. According to the third exemplary embodiment, a character sequence clipping apparatus detects a character sequence by the character sequence tracing, and a quasi-character creating module 1310, a start character sequence component creating module 1320, a character sequence tracking module 1330, and a quasi-character holding module 1340 are provided as shown in the example of FIG. 13.

The quasi-character creating module 1310 is connected to the start character sequence component creating module 1320 and the quasi-character holding module 1340. The quasi-character creating module 1310 creates quasi-characters 1314 from a target image 1308. Then, the quasi-character creating module 1310 causes the quasi-character holding module 1340 to store the quasi-characters 1314 and passes a start signal 1312 to the start character sequence component creating module 1320. Specifically, the quasi-character creating module 1310 extracts the aforementioned pixel blocks from the image 1308 and creates the quasi-characters 1314 from the pixel blocks.

The quasi-character holding module 1340 is connected to the quasi-character creating module 1310, the start character sequence component creating module 1320, and the character sequence tracking module 1330. The quasi-character holding module 1340 stores the quasi-characters 1314 created by the quasi-character creating module 1310. Then, the quasi-character holding module 1340 is accessed by the start character sequence component creating module 1320 and the character sequence tracking module 1330.

The start character sequence component creating module 1320 is connected to the quasi-character creating module 1310, the character sequence tracking module 1330, and the quasi-character holding module 1340. When the start signal 1312 is received, the start character sequence component creating module 1320 creates the start character sequence component 1322 based on the quasi-characters 1314 held in the quasi-character holding module 1340. Specifically, start character sequence component creating module 1320 selects a quasi-character 1314 at the left end in the image 1308, creates a character sequence component based on the quasi-character 1314 along with the other quasi-character sequences 1314 within a predetermined distance from the quasi-character 1314, and measures the size (t) of the character sequence component. Here, θ(the direction of the character sequence component) and p (the interval between character sequence components) may be set to predetermined values.

The character sequence tracking module 1330 is connected to the start character sequence component creating module 1320 and the quasi-character holding module 1340. The character sequence tracking module 1330 has a configuration described in the aforementioned first or second exemplary embodiment. That is, the character sequence tracking module 1330 receives the start character sequence component 1322 and outputs the character sequence 1332 based on the quasi-characters 1314 in the quasi-character holding module 1340.

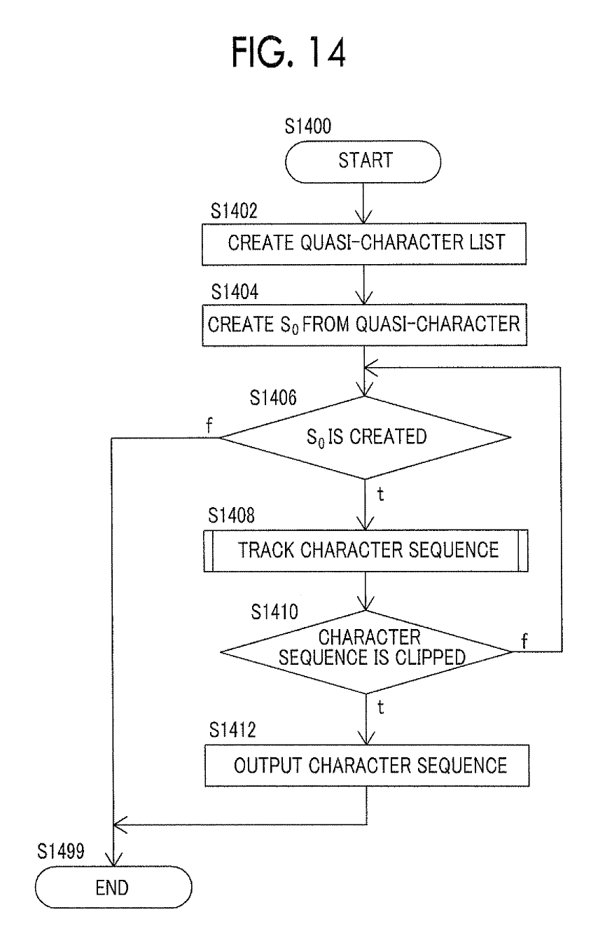

FIG. 14 is a flowchart showing a processing example according to the third exemplary embodiment.

In Step S1402, the quasi-character creating module 1310 creates a quasi-character list.

In Step S1404, the start character sequence component creating module 1320 creates s₀ from the quasi-characters.

In Step S1406, the start character sequence component creating module 1320 determines whether or not s₀ has been created, and the processing proceeds to Step S1408, or otherwise the processing is completed (Step S1499).

In Step S1408, the character sequence tracking module 1330 performs the character sequence tracking processing.

In Step S1410, the character sequence tracking module 1330 determines whether or not a character sequence has been clipped, and the processing proceeds to Step S1412 when a character sequence has been clipped, or otherwise the processing from Step S1406 is performed.

In Step S1412, the character sequence tracking module 1330 outputs the character sequence.

### Fourth Exemplary Embodiment

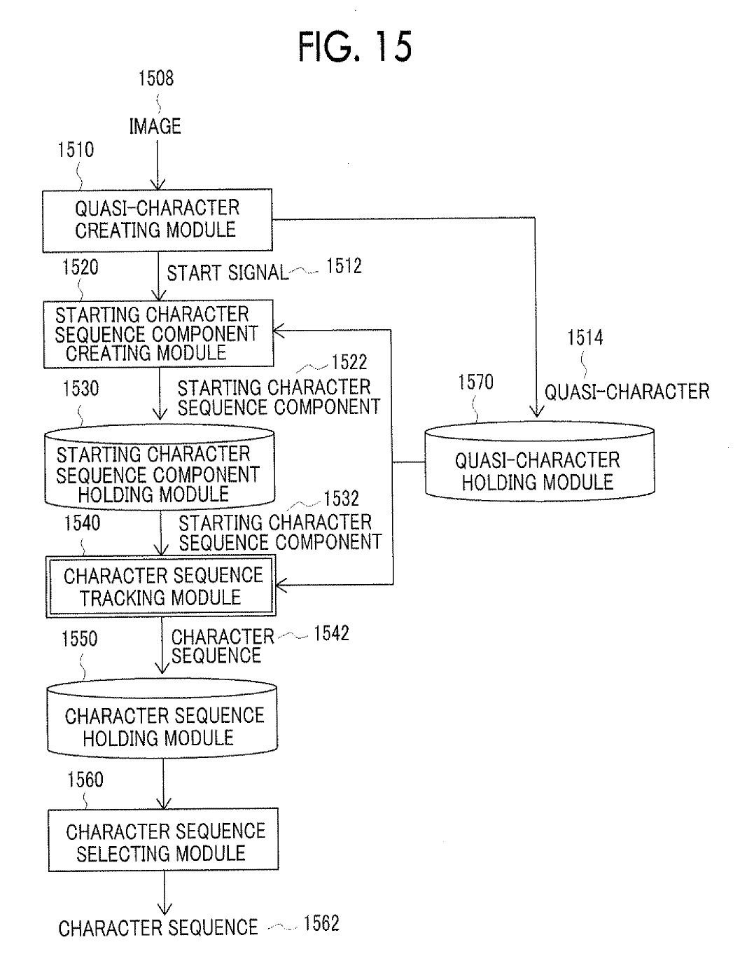

FIG. 15 is a conceptual module configuration diagram of a configuration example according to a fourth exemplary embodiment. According to the fourth exemplary embodiment, multiple character sequences are extracted, and a character sequence is selected from among the multiple character sequences, and a quasi-character creating module 1510, a start character sequence component creating module 1520, a start character sequence component holding module 1530, a character sequence tracking module 1540, a character sequence holding module 1550, a character sequence selecting module 1560, and a quasi-character holding module 1570 are provided as shown in the example of FIG. 15.

According to the aforementioned exemplary embodiments, accuracy for the detection of a character sequence depends on a predicted character sequence component as an initial value. Thus, multiple start character sequence components are created, and an appropriate character sequence is selected from multiple character sequences detected by the start character sequence components.

The quasi-character creating module 1510 is connected to the start character sequence component creating module 1520 and the quasi-character holding module 1570. The quasi-character creating module 1510 is the same as the quasi-character creating module 1310 in the third exemplary embodiment.

The quasi-character holding module 1570 is connected to the quasi-character creating module 1510, the start character sequence component creating module 1520, and the character sequence tracking module 1540. The quasi-character holding module 1570 is the same as the quasi-character holding module 1340 in the third exemplary embodiment.

The start character sequence component creating module 1520 is connected to the quasi-character creating module 1510, the start character sequence component holding module 1530, and the quasi-character holding module 1570. The start character sequence component creating module 1520 is the same as the start character sequence component creating module 1320 an the third exemplary embodiment. However, start character sequence component creating module 1520 creates multiple start character sequence components 1522 and causes the start character sequence component holding module 1530 to store the multiple start character sequence components 1522. The quasi-characters 1514 may randomly be selected or selected based on a predetermined rule (quasi-characters 1514 may be selected in an order from the left end, for example) in order to create the first character sequence component among the multiple first character sequence components.

The start character sequence component holding module 1530 is connected to the start character sequence component creating module 1520 and the character sequence tracking module 1540. The start character sequence component holding module 1530 holds the multiple start character sequence components 1522 created by the start character sequence component creating module 1520. Then, the start character sequence component holding module 1530 is accessed by the character sequence tracking module 1540.

The character sequence tracking module 1540 is connected to the start character sequence component holding module 1530, the character sequence holding module 1550, and the quasi-character holding module 1570. The character sequence tracking module 1540 has the same configuration as that in the aforementioned first or second exemplary embodiment. That is, character sequence tracking module 1540 extracts start character sequence components 1532 from the start character sequence component holding module 1530, creates a character sequences 1542 for each start character sequence components 1532 based on the quasi-characters 1514 in the quasi-character holding module 1570, and causes the character sequence holding module 1550 to store the multiple character sequences 1542.

The character sequence holding module 1550 is connected to the character sequence tracking module 1540 and the character sequence selecting module 1560. The character sequence holding module 1550 stores the multiple character sequences 1542.

The character sequence selecting module 1560 is connected to the character sequence holding module 1550. The character sequence selecting module 1560 selects an appropriate character sequence from the multiple character sequences 1542 in the character sequence holding module 1550. For example, the character sequence selecting module 1560 determines whether or not there is a character sequence including the same character sequence components, and the following character sequence is selected when there is a character sequence including the same character sequence components. For example, a configuration is applicable in which a character sequence with a longer length as compared with lengths of the other character sequences is selected. Alternatively, another configuration is also applicable in which a less distorted character sequence is selected as compared with curving degrees (addition of the degree of change of θ) of the other character sequences. Furthermore, a character sequence which is parallel with another character sequence may be selected.

### Fifth Exemplary Embodiment

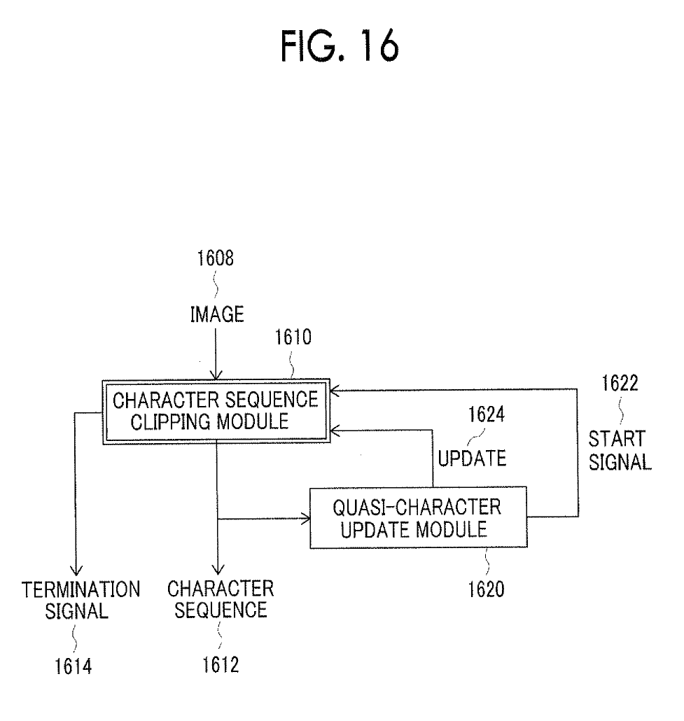

FIG. 16 is a conceptual module configuration diagram of a configuration example according to a fifth exemplary embodiment. According to the fifth exemplary embodiment, multiple character sequences are detected, and a character sequence clipping module 1610 and a quasi-character update module 1620 are provided as shown in the example of FIG. 16.

The character sequence clipping module 1610 is connected to the quasi-character update module 1620. The character sequence clipping module 1610 has a configuration in one of the aforementioned first to fourth exemplary embodiments. That is, character sequence clipping module 1610 receives the image 1608, starts the processing by the start signal 1622 or the update 1624 by the quasi-character update module 1620, outputs the character sequence 1612, and outputs a termination signal 1614 when there is no quasi-character to be processed (for example, when the start character sequence component creating module 1320 in the third exemplary embodiment cannot create the start character sequence component 1322, or when the start character sequence component creating module 1520 in the fourth exemplary embodiment cannot create the start character sequence component 1522).

The quasi-character update module 1620 is connected to the character sequence clipping module 1610. The quasi-character update module 1620 gives information indicating that the detection has already been performed to the quasi-characters included in the detected character sequence 1612.

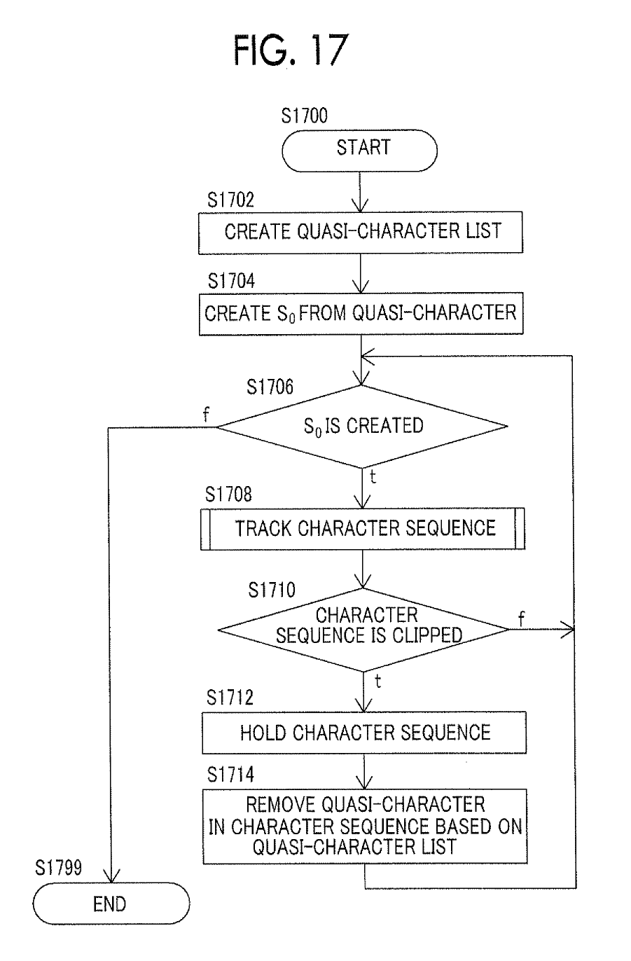

FIG. 17 is a flowchart showing a processing example according to the fifth exemplary embodiment.

In Step S1702, the character sequence clipping module 1610 creates the quasi-character list.

In Step S1704, the character sequence clipping module 1610 creates s₀ from the quasi-characters.

In Step S1706, the character sequence clipping module 1610 determines whether or not s₀ has been created, and the processing proceeds to Step S1708 when s₀ has been created, or otherwise the processing is completed (Step S1799).

In Step S1708, the character sequence clipping module 1610 performs the character sequence tracking processing.

In Step S1710, the character sequence clipping module 1610 determines whether or not a character sequence has been clipped, and the processing proceeds to Step S1712 when a character sequence has been clipped, or otherwise the processing from Step S1706 is performed.

In Step S1712, the character sequence clipping module 1610 holds the character sequence.

In Step S1714, the quasi-character update module 1620 removes the quasi-characters included in the character sequence from the quasi-character list.

### Sixth Exemplary Embodiment

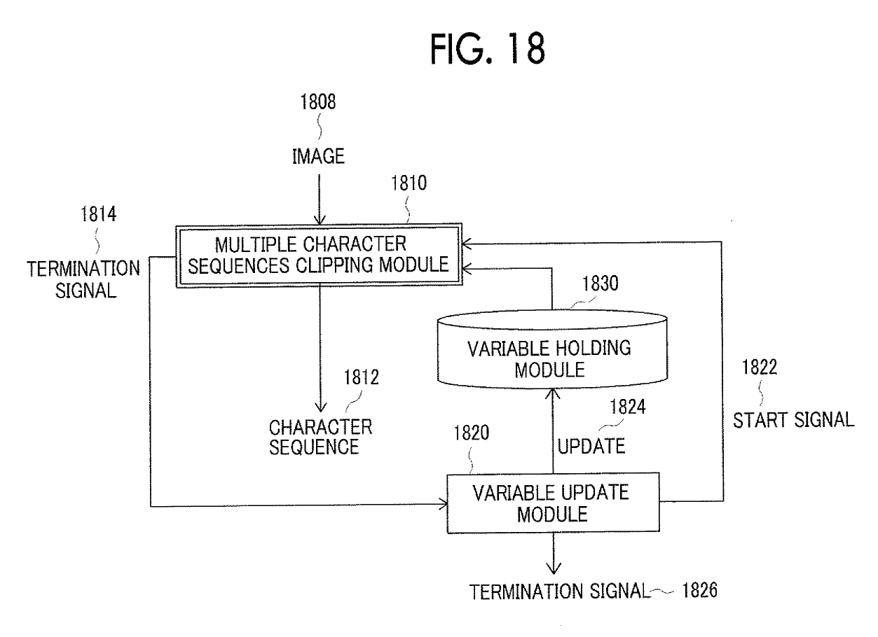

FIG. 18 is a conceptual module configuration diagram of a configuration example according to a sixth exemplary embodiment. According to the sixth exemplary embodiment, detection parameters are updated, and a multiple character sequences clipping module 1810, a variable update module 1820, and a variable holding module 1830 are provided as shown in the example of FIG. 18.

According to the sixth exemplary embodiment, a character sequence included in the document image is detected based on a greedy algorithm. The greedy algorithm is an approach according to which every time a quasi-character is detected, the quasi-character is removed from the detection targets. According to the greedy algorithm, the number of targets to be referred to is gradually decreased.

By detecting a detection target character sequence with a parameter, which is approximately a predetermined value, with priority at this time, detection accuracy is stabilized in some cases. For example, under a condition that it is assumed that a part in which single characters are at closer positions is more likely a character sequence, a part in which intervals between character sequence components are shorter is detected and excluded with priority.

The multiple character sequences clipping module 1810 is connected to the variable update module 1820 and the variable holding module 1830. The multiple character sequences clipping module 1810 is one of the aforementioned first to fifth exemplary embodiment. That is, the multiple character sequences clipping module 1810 receives an image 1808, and the start character sequence component creating module 1320 and the character sequence tracking module 1330 in the first, second, or third exemplary embodiment, the start character sequence component creating module 1520, and the character sequence tracking module 1540 in the fourth exemplary embodiment uses a parameter within a variable holding module 1830, and outputs a character sequence 1812. When the parameter is updated by the variable update module 1820, the multiple character sequences clipping module 1810 receives a start signal 1822, uses the updated parameter, and outputs the character sequence 1812. When it is determined that the processing is to be completed (that is, when there is no start character sequence component which can be detected by the current variable holding module 1830), the multiple character sequences clipping module 1810 passes a termination signal 1814 to the variable update module 1820.

The variable update module 1820 is connected to the multiple character sequences clipping module 1810 and the variable holding module 1830. When the termination signal 1814 is received from the multiple character sequences clipping module 1810, the variable update module 1820 updates 1824 the parameter in the variable holding module 1830. When the parameter reaches a termination value after the updating, the termination signal 1826 is output to complete the processing.

The variable holding module 1830 is connected to the multiple character sequences clipping module 1810 and the variable update module 1820. The variable holding module 1830 holds the aforementioned parameter, and the parameter is updated by the variable update module 1820 and accessed by the multiple character sequences clipping module 1810.

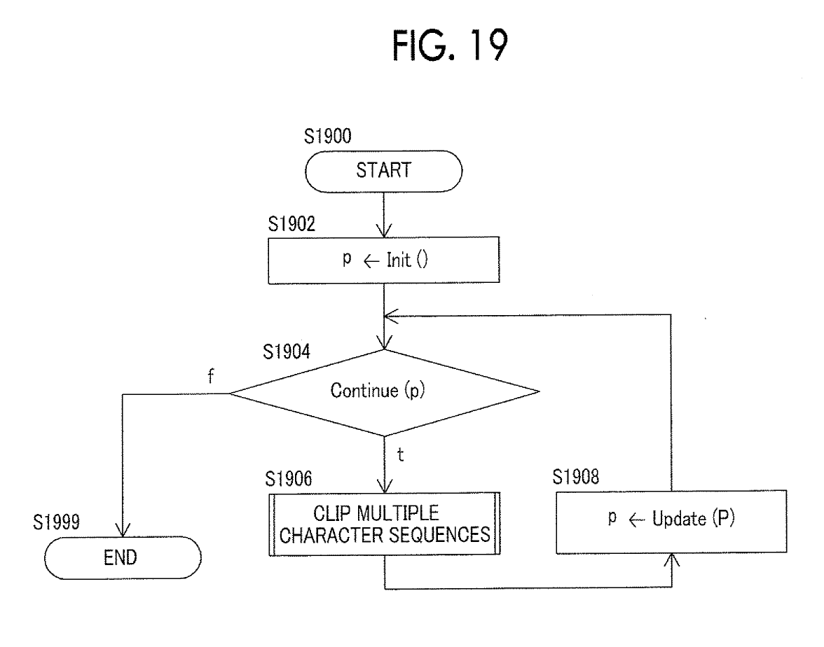

FIG. 19 is a flowchart showing a processing example according to the sixth exemplary embodiment.

P represents the parameter.

Init ( ) represents a function which initializes the parameter.

Update (P) represents a function which updates the parameter P.

Continue (P) represents a function which determines that the parameter P satisfies a termination condition.

For example, when the parameter P is a distance between character sequence components, a minimum parameter P is determined based on Init ( ) the processing of adding a differential value is performed based on Update (P), and it is determined that the parameter P reaches a predetermined value based on Continue (P).

In Step S1902, the variable update module 1820 substitutes Init ( ) into the parameter P.

In Step S1904, the variable update module 1820 determines whether or not Continue (P) is satisfied, and the processing proceeds to Step S1906 if so, or otherwise the processing is completed (Step S1999).

In Step S1906, the multiple character sequences clipping module 1810 clips multiple character sequences.

In Step S1908, the variable update module 1820 substitutes Update (P) into the parameter P.

### Seventh Exemplary Embodiment

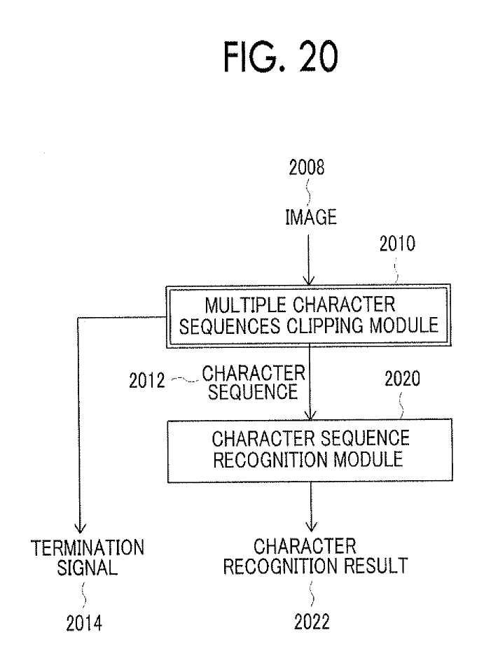

FIG. 20 is a conceptual module configuration diagram of a configuration example according to a seventh exemplary embodiment. According to the seventh exemplary embodiment, a character sequence is clipped and subjected to character recognition processing, and a multiple character sequences clipping module 2010 and a character sequence recognition module 2020 are provided as shown in the example of FIG. 20.

The multiple character sequences clipping module 2010 is connected to the character sequence recognition module 2020. The multiple character sequences clipping module 2010 is one of the aforementioned first to sixth exemplary embodiments. That is, the multiple character sequences clipping module 2010 receives an image 2008, clips a character sequence 2012 in the image 2008, and passes the character sequence 2012 to the character sequence recognition module 2020. When there is no character sequence to be clipped, a termination signal 2014 is output.

The character sequence recognition module 2020 is connected to the multiple character sequences clipping module 2010. The character sequence recognition module 2020 recognizes an image of the character sequence 2012 and outputs a character recognition result 2022. A known method may be used for the character recognition.

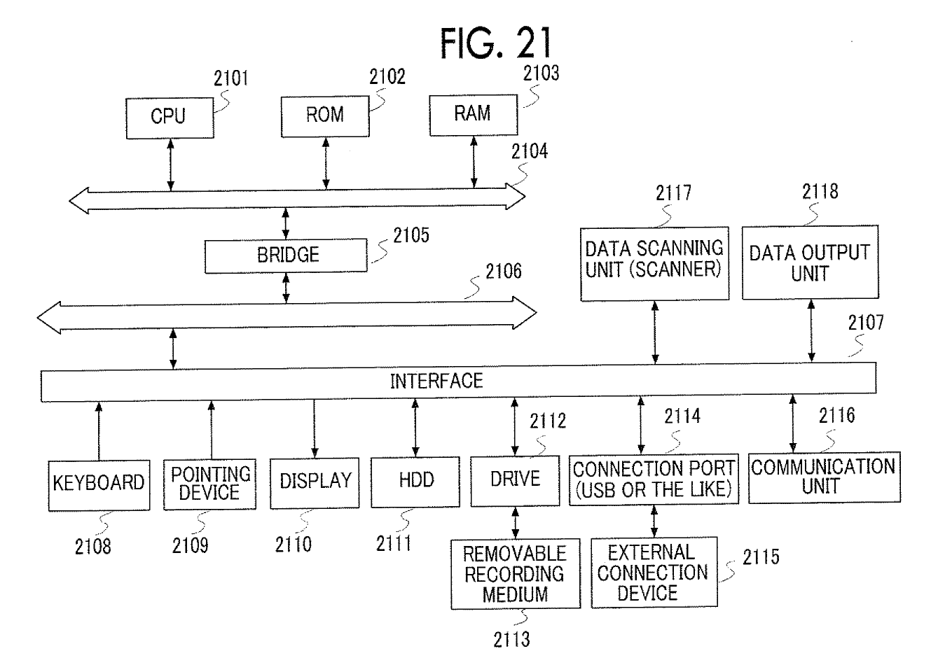

Referring to FIG. 21, a hardware configuration example of the image processing apparatus according to the exemplary embodiments will be described. The configuration shown in FIG. 21 is configured by a personal computer (PC), for example, and the drawing shows a hardware configuration example provided with a data reading unit 2117 such as a scanner and a data output unit 2118 such as a printer.

A CPU (Central Processing Unit) 2101 is a control unit which executes processing based on a computer program describing an execution sequence of the various modules described in the aforementioned exemplary embodiments, that is, the character sequence component prediction module 110, the character sequence component detection module 120, the character sequence component correction module 130, the termination processing module 160, the reciprocation module 1270, the quasi-character creating module 1310, the start character sequence component creating module 1320, the character sequence tracking module 1330, the quasi-character creating module 1510, the start character sequence component creating module 1520, the character sequence tracking module 1540, the character sequence selecting module 1560, the character sequence clipping module 1610, the quasi-character update module 1620, the multiple character sequences clipping module 1810, the variable update module 1820, the multiple character sequences clipping module 2010, the character sequence recognition module 2020, and the like.

A ROM (Read Only Memory) 2102 stores programs, computation parameters, and the like used by the CPU 2101. A RAM (Random Access Memory) 2103 stores programs used in the execution by the CPU 2101, parameters which appropriately change in the execution, and the like. Such components are mutually connected via a host bus 2104 configured by a CPU bus or the like.

The host bus 2104 is connected to an external bus 2106 such as a PCI (Peripheral Component Interconnect/Interface) bus via a bridge 2105.

A pointing device 2109 such as a keyboard 2108, or a mouse is an input device operated by an operator. Examples of a display 2110 include a liquid crystal display apparatus, a CRT (Cathode Ray Tube), and the like, and the display 2110 displays various information items as text information or image information.

An HDD (Hard Disk Drive) 2111 incorporates a hard disk and drives the hard disk to record or reproduce a program executed by the CPU 2101 or information. The hard disk stores target images, information relating to character sequence components, character sequence, and the like. Furthermore, other various computer programs such as various data processing programs are stored therein.

A drive 2112 reads data or programs recorded in a mounted removable recording medium 2113 such as a magnetic disk, an optical disc, a magneto-optical disc, or a semiconductor memory and supplies the data or the programs to the RAM 2103 connected via the interface 2107, the external bus 2106, the bridge 2105, and the host bus 2104. The removable recording medium 2113 may also be used as the same data recording region as the hard disk.

A connection port 2114 is a port to connect the external connected device 2115 and includes a connection unit such as a USB, an IEEE 1394. The connection port 2114 is connected to the CPU 2101 and the like via the interface 2107, the external bus 2106, the bridge 2105, the host bus 2104, and the like. A communication unit 2116 is connected to a communication line to execute data communication processing with the external devices. A data reading unit 2117 is a scanner, for example, to execute document reading processing. A data output unit 2118 is a printer, for example, to execute document data output processing.

In addition, the hardware configuration of the image processing apparatus shown in FIG. 21 is one configuration example, the exemplary embodiments are not limited to the configuration shown in FIG. 21, and any configuration with which it is possible to execute the modules described in the exemplary embodiments is applicable. For example, a part of the modules may be configured by dedicated hardware (for example, an Application Specific Integrated Circuit (ASIC) or the like), a configuration is also applicable in which a part of the modules are in an external system which is connected via a communication line, or multiple systems shown in FIG. 21 are connected to each other via communication lines such that the systems cooperate with each other. In addition, the modules may be built in a copy machine, a facsimile machine, a scanner, a printer, or a complex machine (an image processing apparatus with two or more functions of a scanner, a printer, a copy machine, a facsimile machine, and the like).

In addition, the aforementioned various exemplary embodiments may be combined (including a case in which a module in a certain exemplary embodiment is added to another exemplary embodiment, a case in which a module in a certain exemplary embodiment is replaced with a module in another exemplary embodiment, and the like, for example). Further, a technique described in related art may employ as processing content for each module.

In addition, although the aforementioned exemplary embodiments are described with the use of equations, such equations also includes equivalents thereof. The equivalents thereof includes a change in the equations at a degree at which the final result is not effected, solution of the equations based on an algorithmic solving method, and the like as well as the equations themselves.

Moreover, the program described above may be stored and provided in a recording medium, or the program may be provided via a communication unit. In such a case, the program described above may be understood as an invention of “a computer-readable recording medium that records the program”.

The “computer-readable recording medium that records the program” means a computer readable recording medium that records the program, which is used for installing, executing, and distributing the program.

In addition, examples of the recording medium include “a DVD-R, a DVD-RW, a DVD-RAM, or the like” which are standards defined by the DVD forum, “a DVD+R, a DVD+RW, or the like” which are standards defined by DVD+RW, all of which are digital versatile discs (DVD), a read only memory (CD-ROM), a CD recordable (CD-R), a CD rewritable (CD-RW), or the like, all of which are compact discs (CD), a Blu-ray Disc (registered trademark), a magneto-optical disc (MO), a flexible disk (FD), a magnetic tape, a hard disk, a read only memory (ROM), an Electrically Erasable Programmable Read-Only Memory (EEPROM (registered trademark)), a flash memory, a random access memory (RAM), and the like.

In addition, the program or a part thereof may be recorded in such a recording medium and stored and distributed. Moreover, the program may be delivered via communication using a local area network (LAN), a metropolitan area network (MAN), a wide area network (WAN), a wired network used for the Internet, an intranet, an extranet, or the like, a wireless communication network, or a delivery medium of the combination thereof, or transported via a carrier wave.

Furthermore, the program may be a part of another program or may be recorded in a recording medium with another program. In addition, the program may be divided and recorded in multiple recording media. Moreover, the program may be recorded in any recoverable state including a compressed state or a coded state.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a receiving unit that receives a size of a first character sequence component, a direction from a prefix character sequence component as a character sequence component, which is prefixed before the first character sequence component, to the first character sequence component, and a distance from the prefix character sequence component to the first character sequence component, as information relating to the first character sequence component in an image;
a predicting unit that predicts a second character sequence component following the first character sequence component based on the information relating to the first character sequence component received by the receiving unit;
a detecting unit that detects the second character sequence component in the image based on the second character sequence component predicted by the predicting unit;
a correcting unit that corrects information relating to the second character sequence component detected by the detecting unit based on information relating to character sequence components in the past; and
a control unit that controls the receiving unit to receive as a next first character sequence component the second character sequence component corrected by the correcting unit and causes the predicting unit, the detecting unit, and the correcting unit to repeat processing.

2. The image processing apparatus according to claim 1,
wherein the receiving unit further receives a differential value in a direction from the prefix character sequence component to the first character sequence component as the information relating to the first character sequence component, and
wherein the predicting unit predicts the second character sequence component based on the differential value in the direction, which has been further received by the receiving unit.

3. The image processing apparatus according to claim 1,
wherein the control unit controls to complete the repeated processing when the detecting unit has not detected the second character sequence component or when a difference between the information relating to the second character sequence component detected by the detecting unit and the information relating to the second character sequence component predicted by the predicting unit is greater or not less than a predetermined value.

4. The image processing apparatus according to claim 2,
wherein the control unit controls to complete the repeated processing when the detecting unit has not detected the second character sequence component or when a difference between the information relating to the second character sequence component detected by the detecting unit and the information relating to the second character sequence component predicted by the predicting unit is greater or not less than a predetermined value.

5. The image processing apparatus according to claim 1,
wherein the control unit causes the receiving unit, the predicting unit, the detecting unit, and the correcting unit to repeat the processing on a character sequence component in an opposite direction from a character sequence component at last end to a character sequence component at a first end when the detecting unit has not detected the second character sequence component or when a difference between the information relating to the second character sequence component detected by the detecting unit and the information relating to the second character sequence component predicted by the predicting unit is greater or not less than a predetermined value.

6. The image processing apparatus according to claim 2,
wherein the control unit causes the receiving unit, the predicting unit, the detecting unit, and the correcting unit to repeat the processing on a character sequence component in an opposite direction from a character sequence component at last end to a character sequence component at a first end when the detecting unit has not detected the second character sequence component or when a difference between the information relating to the second character sequence component detected by the detecting unit and the information relating to the second character sequence component predicted by the predicting unit is greater or not less than a predetermined value.

7. A non-transitory computer readable medium storing an image processing program, function as:
a receiving unit that receives a size of a first character sequence component, a direction from a prefix character sequence component as a character sequence component, which is prefixed before the first character sequence component, to the first character sequence component, and a distance from the prefix character sequence component to the first character sequence component, as information relating to the first character sequence component in an image;
a predicting unit that predicts a second character sequence component following the first character sequence component based on the information relating to the first character sequence component received by the receiving unit;
a detecting unit that detects the second character sequence component in the image based on the second character sequence component predicted by the predicting unit;
a correcting unit that corrects information relating to the second character sequence component detected by the detecting unit based on information relating to character sequence components in the past; and
a control unit that controls the receiving unit to receive as a next first character sequence component the second character sequence component corrected by the correcting unit and causes the predicting unit, the detecting unit, and the correcting unit to repeat processing.

8. An image processing method comprising:
receiving a size of a first character sequence component, a direction from a prefix character sequence component as a character sequence component, which is prefixed before the first character sequence component, to the first character sequence component, and a distance from the prefix character sequence component to the first character sequence component, as information relating to the first character sequence component in an image;
predicting a second character sequence component following the first character sequence component based on the information relating to the received first character sequence component;
detecting the second character sequence component in the image based on the predicted second character sequence component;
correcting information relating to the second character sequence component detected based on information relating to character sequence components in the past; and
controlling the reception of the corrected second character sequence component as a next first character sequence component and causing the predicting, detecting, and correcting processing to be repeated.
